(19) United States
(12) Patent Application Publication
(10) Pub. No.: US 2009/0316081 A1
(43) Pub. Date: Dec. 24, 2009

(54) METHOD FOR MANUFACTURING A LIQUID CRYSTAL DISPLAY DEVICE AND MOTHER SUBSTRATE FOR MANUFACTURING THE SAME

(76) Inventors: Takuma NISHIDA, Tokyo (JP); Yuushi Matsumoto, Saitama-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/478,681

(22) Filed: Jun. 4, 2009

(30) Foreign Application Priority Data
Jun. 5, 2008 (JP) 2008-148375

(51) Int. Cl. G02F 1/133; B26F 3/00

(52) U.S. Cl. 349/73; 225/2

(57) ABSTRACT

A method for manufacturing a liquid crystal display device includes: forming a first crack, on a mother substrate for use in a liquid crystal display device, on one side of the mother substrate extending along a first direction; forming a first scribe line by laser irradiation along the first crack in a second direction which intersects with the first direction; forming a second crack on one side extending along a second direction on the mother substrate; forming a third crack at an intersection where the first scribe line intersects with a line in the first direction through the second crack; and forming a second scribe line by laser irradiation along the second crack in the first direction through the third crack.

### CROSS-REFERENCE TO RELATED APPLICATIONS

This application is based upon and claims the benefit of priority from prior Japanese Patent Application No. 2008-148375, filed Jun. 5, 2008, the entire contents of which are incorporated herein by reference.

### TECHNICAL FIELD

The present invention relates to a method for manufacturing a liquid crystal display device.

### BACKGROUND OF THE INVENTION

Various methods for manufacturing liquid crystal display devices by dividing a large-sized mother glass substrate are widely employed. A conventional method of this type is disclosed in Japanese Patent Disclosure (KOKAI) NO. 2000-167681, in which a large-sized glass substrate is divided by laser irradiation into smaller glass substrates. Another process is disclosed in Japanese Patent Disclosure (KOKAI) NO. 2007-314392. In this process, firstly, fused portions are formed by laser irradiation of a glass substrate. Next, scribe lines are formed with a glass cutter on the fused portions. Then the substrate is divided along the scribe lines.

As for a technique to divide a large-sized substrate into cells, for example, there is a process to cut each cell out after the substrate is first cut into rectangles from the mother substrate (referred to as a first cutting method). There is another process to cut each cells out at one time from the large-sized mother substrate (referred to as a second cutting method). The first cutting method may increase production costs due to the increase of the number of process steps and taking more time. On the other hand, the second cutting method has an advantage of not increasing the production costs.

However, a process combining the process described in Japanese Patent Disclosure (KOKAI NO. 2007-314392) and the second cutting method has the following problem. In this process, a first scribe line is formed on a substrate. Subsequently, a second scribe line is formed so that the second line intersects with the first line. At this time, a cracking growth of the second scribe line may stop at the intersection.

### BRIEF SUMMARY OF THE INVENTION

According to a first aspect of the present invention, there is provided a method for manufacturing a liquid crystal display device, comprising forming a first crack, on a mother substrate for use in a liquid crystal display device, on one side of the mother substrate extending along a first direction; forming a first scribe line by laser irradiation along the first crack in a second direction which intersects with the first direction; forming a second crack on one side extending along a second direction on the mother substrate; forming a third crack at an intersection where the first scribe line intersects with a line in the first direction through the second crack; and forming a second scribe line by laser irradiation along the second crack in the first direction through the third crack.

According to a second aspect of the present invention, there is provided a mother substrate for use of manufacturing a liquid crystal display device including pixels arranged in a matrix shape, comprises a substrate made of glass, a plurality of panel areas formed on the substrate corresponding to each of the pixels in the matrix shape, first and second scribe lines between the adjacent panel areas, a first crack formed on one side of the substrate extending along a first direction on the substrate, a second crack formed on one side of the substrate extending along a second direction on the substrate, and a third crack formed at an intersection where a line in the second direction through the first crack intersects with a line in the first direction through the second crack.

According to a third aspect of the present invention, there is provided a liquid crystal display devise, including pixels arranged in a matrix shape, of manufacture prepared by process comprising the steps of a step to prepare a first and second mother substrates each including, a substrate made of glass, a plurality of panel areas formed on the substrate corresponding to each of pixels in a matrix shape, first and a second scribe lines between adjacent panel areas, a first crack formed on one side of the substrate extending along a first direction on the substrate, a second crack formed on one side of the substrate extending along second direction on the substrate, a third crack formed at an intersection where a line in the second direction through the first crack intersects with a line in the first direction through the second crack, respectively, a step to attach the first and second mother substrates forming a gap therebetween by a sealing member; a step to inject a liquid crystal material in the gap, and a step to attach the first and second mother substrates into each sell along the scribe lines.

Additional features and advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows a view of a liquid crystal display panel in accordance with a first embodiment of the present invention.

FIG. 2 schematically shows a sectional view of the construction of pixel electrodes and switching elements of the panel shown in FIG. 1.

FIG. 3 shows a schematic diagram of a method for manufacturing a liquid crystal display device.

FIG. 4 shows a schematic diagram of a method for manufacturing a liquid crystal display panel in accordance with an embodiment of the present invention.

FIG. 5 schematically shows a view of a mother glass substrate having a plurality of liquid crystal display panels before cutting down, for explaining the method in accordance with the first embodiment of the present invention.

FIG. 6 shows a schematic diagram of a method for manufacturing liquid crystal display panels in accordance with a second embodiment of the present invention, including a step to form a crack.

FIG. 7 shows a schematic diagram of a method for manufacturing liquid crystal display panels in accordance with a third embodiment of the present invention, including a step to form a crack.

FIG. 8 shows a schematic diagram of a method for manufacturing liquid crystal display panels in accordance with a fourth embodiment of the present invention, including a step to form a crack.

### DETAILED DESCRIPTION OF THE INVENTION

Preferred embodiments of the present invention are demonstrated hereinafter with reference to the accompanying drawings.

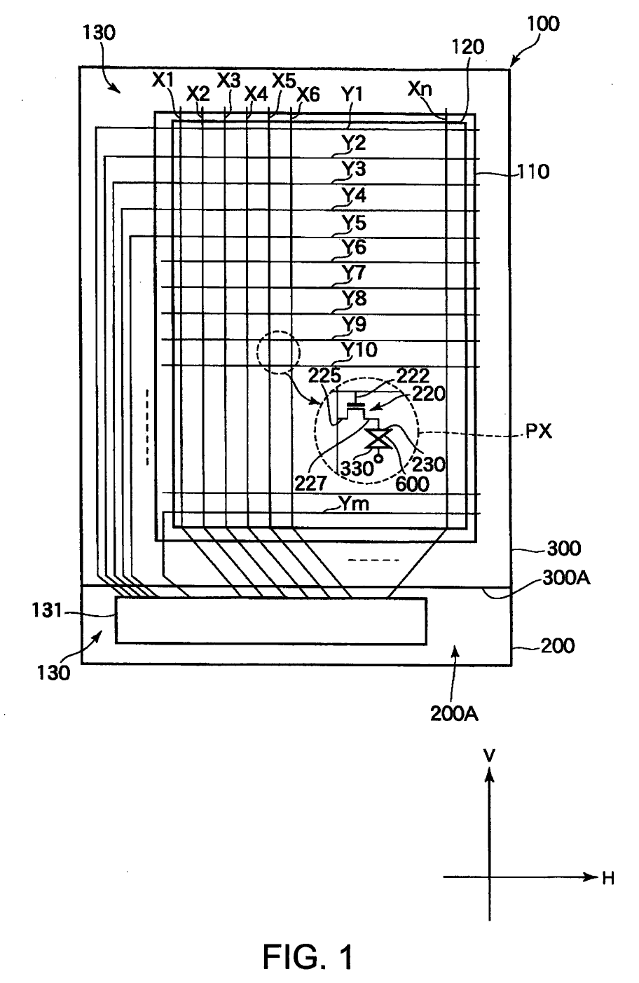

FIG. 1 schematically shows a view of a liquid crystal display panel 100, in accordance with a first embodiment of the invention. The liquid crystal display panel 100 is approximately rectangular and flat, and is included in a liquid crystal display device. The panel 100 includes a pair of substrates, i.e., an array substrate 200 and a counter substrate 300, and a liquid crystal layer 600 held therebetween, as shown in FIG. 1.

The array substrate 200 and the counter substrate 300 are sealed with a sealing layer 110. The liquid crystal display panel 100 includes a display area 120 surrounded by the sealing layer 110. The display area 120 includes pixels PX arranged in matrix.

The array substrate 200 includes a plurality of scanning lines Y (1, 2, 3, . . . m), a plurality of signal lines X (1, 2, 3, . . . n), switching elements 220, and pixel electrodes 230 on the display area 120. The scanning lines Y extend along a row direction H of the pixels PX. The signal lines X extend along a column direction V of the pixels PX. Switching elements 220 are disposed at intersections where the signal lines X intersect with the scanning lines Y at the pixels PX. Pixel electrodes 230 are disposed on respective pixels PX, and coupled to the switching elements 220.

The liquid crystal display panel 100 also includes a connection area 131 that is disposed at an outer periphery of the portion 130 arranged outside of the display area 120. The connection area 131 may be coupled to driver IC chips which function as signal sources, or a flexible wiring board. In the example shown in FIG. 1, the connection area 131 is disposed on an extending portion 200A of the array substrate 200 which extends to the outside from an edge 300A of the counter substrate 300.

The respective scanning lines Y are coupled to the connection area 131 via the outer periphery of the portion 130. Similarly, the respective signal lines X are coupled to the connection area 131 via the outer periphery of the portion 130.

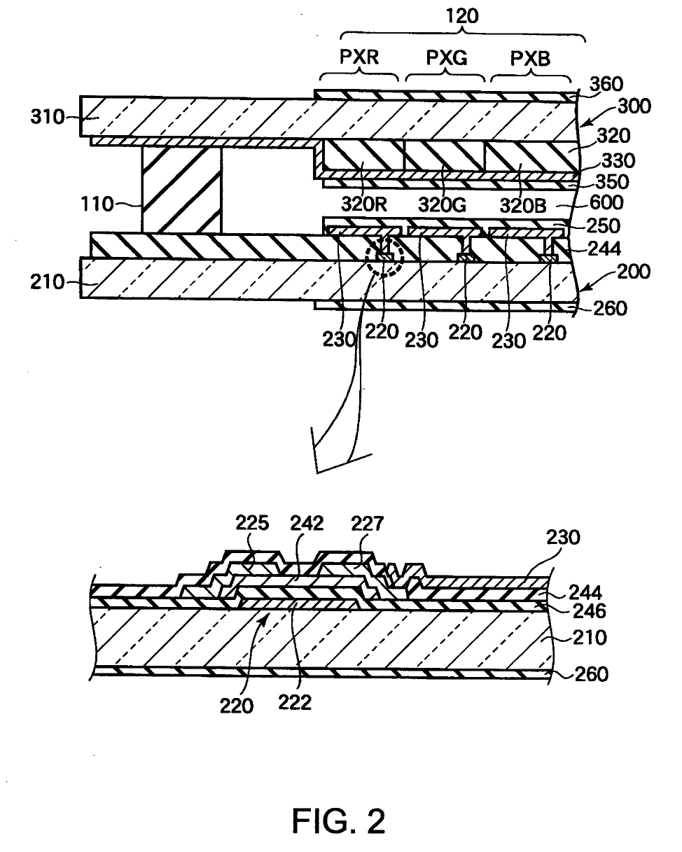

FIG. 2 schematically shows a sectional view of the construction of the pixel electrodes 230 and the switching elements 220 of the panel 100. As shown in FIG. 2, the array substrate 200 includes an insulating substrate 210 made of a light transmissive material such as a glass. The switching elements 220 are disposed on the insulating substrate 210. The switching elements 220 may, for example, be provided as thin film transistors (TFTs).

FIG. 2 includes an enlarged view of the construction of one of the switching elements 220. With reference to the enlarged view, TFTs include semiconductor films 242 made of amorphous silicon or polysilicon and the like. Gate electrodes 222 of the switching elements 220 are coupled to the scanning lines Y, or integrally formed with the scanning lines Y. Source electrodes 225 of the switching elements 220 are coupled to the signal lines X, or integrally formed with the signal lines X. Drain electrodes 227 of the switching elements 220 are coupled to the pixel electrodes 230. The switching elements 220 are disposed on the insulating substrate 210.

The semiconductor films 242 of the switching elements 220 are disposed on gate insulating films 246 which overlie the gate electrodes 222. The semiconductor films 242 couple the source electrodes 225 of the switching elements 220 to the drain electrodes 227.

An insulating interlayer 244 overlies the source electrodes 225 and the drain electrodes 227. The pixel electrodes 230 are disposed on the insulating interlayer 244 corresponding to the respective pixel PX. The pixel electrodes 230 are electrically coupled to the drain electrodes 227 through contact holes formed on the insulating interlayer 244.

The pixel electrodes 230 may be made of a light transmissive conductive material, for example, indium tin oxide (ITO), indium zinc oxide (IZO) and the like, for use in a transmissive liquid crystal display panel. The transmissive liquid crystal display panel displays an image by transmitting light from a backlight unit. On the other hand, the pixel electrodes 230 may be made of a light reflective conductive material, for example, aluminum (Al), molybdenum (Mo) and the like, for use in a reflective liquid crystal display panel. The reflective liquid crystal display panel displays an image by reflecting light.

The counter substrate 300 includes an insulating substrate 310 made of a light transmissive glass and the like, and a counter electrode 330 disposed opposite to the pixel electrodes 230 via the liquid crystal layer 600 on the display area 120.

The counter electrode 330 is configured as a common supply of electric power to the plurality of pixels PX that are red color pixels PXR, green color pixels PXG, and blue color pixels PXB, for use in a color liquid crystal display device.

In accordance with the first embodiment as shown in FIG. 2, the counter substrate 300 includes a color filter layer 320 on the display area 120, which is formed on one face of the insulating substrate 310, i.e., the face confronting the liquid crystal layer 600.

The color filter layer 320 includes a red color filter 320R, a green color filter 320G, and a blue color filter 320B. Alternatively, the color filter layer 320 may be disposed on a side of the array substrate 200.

The liquid crystal layer 600 on the display area 120 is interposed between the counter electrode 330 made of a light transmissive conductive material, for example ITO, IZO and the like, and the pixel electrodes 230 disposed opposite to the counter electrode 330.

Alignment films 250 and 350 overlie surfaces of the array substrate 200 and the counter substrate 300, respectively. The array substrate 200 and the counter substrate 300 are disposed with a predetermined gap by means of spacers (not shown). The liquid crystal layer 600 is made of a liquid crystal material that fills the gap between the array substrate 200 and the counter substrate 300.

For use in a transmissive liquid crystal display panel, an optical element 260 is provided outside of the array substrate 200, and an optical element 360 is provided outside of the counter substrate 300. That is, the optical elements 260 and 360 are provided on sides of array substrate 200 and counter substrate 300, respectively, opposite to the sides facing the liquid crystal layer 600, respectively.

The optical elements 260 and 360 include polarizers which set a polarization direction based on a characteristic of the liquid crystal layer 600.

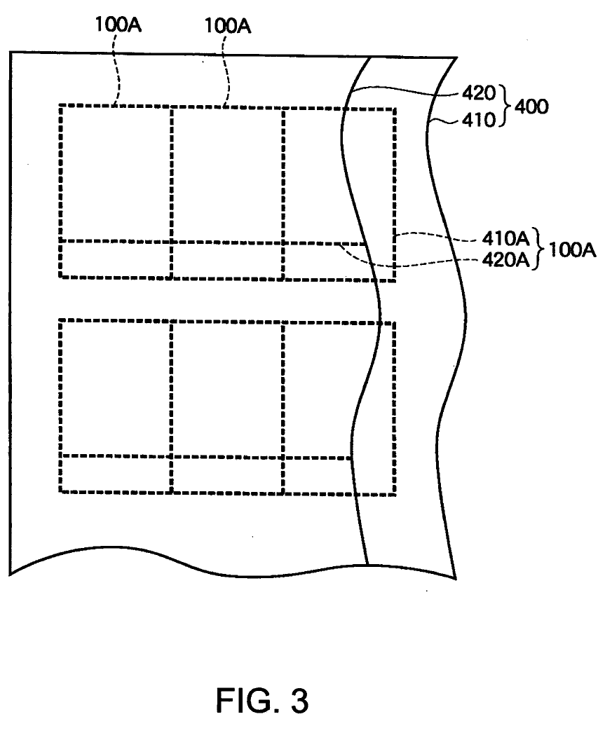

FIG. 3 is a schematic diagram of a method for manufacturing a liquid crystal display device according to an embodiment of the present invention.

With reference to FIG. 3, two large-sized mother glass substrates 410 and 420 are prepared. The first mother substrate 410 is formed for use in the array substrate 200. The second mother substrate 420 is formed for use in the counter substrate 300.

The first mother substrate 410 and the second mother substrate 420 are sealed so as to obtain a pair of mother substrates 400, as shown in FIG. 3. The switching elements 220 and the pixel electrodes 230 are formed on respective areas 410A for the array substrates 200 of the first mother substrate 410. An area 420A on the counter substrates 300 of the second mother substrate 420 is smaller than the area 410A. The counter electrodes 330 are formed on respective areas 420A. Then the respective areas 410A and 420A are sealed with a sealing member.

A plurality of the liquid crystal display panels 100 are divided from the pair of mother substrates 400. That is, the respective areas 410A are divided from the first mother substrate 410, and the respective areas 420A are divided from the second mother substrate 420 at one time. Each of the plurality of liquid crystal display panels 100 is formed in this manner.

A method of one drop fill may be applied to each panel 100 before the first mother substrate 410 and the second mother substrate 420 are sealed with the sealing layer 110. Alternatively, a liquid crystal injection method may be applied to each panel area 100A for filling liquid crystal material after the plurality of liquid crystal display panels 100 are divided from the pair of mother substrates 400. In the one drop fill method, the sealing layer 110 is applied to each panel area 100A to surround the display area 120. Then the liquid crystal material is poured into the area surrounded by the sealing layer 110. In the liquid crystal injection method, the sealing layer 110 is applied to each panel area 100A. Then the liquid crystal material is injected from the inlet.

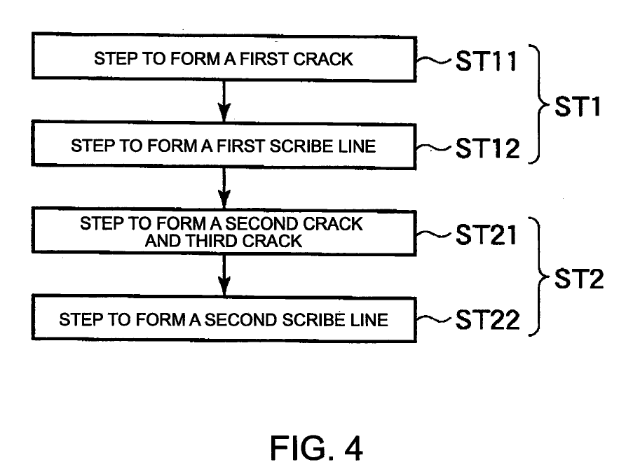

Steps to divide the pair of mother substrates 400 will be described with reference to FIGS. 4 to 8. The steps to divide the pair of mother substrates 400 utilize a dividing apparatus. The dividing apparatus includes cracking equipment, which has a crack blade and scribing equipment. The crack blade makes cracks on the glass substrate used as the mother substrate. The crack blade is made of a material harder than the glass substrate, for example a diamond and the like. The cracking equipment has a stage for holding the mother substrate. The crack which is a starting point in the process of scribing the glass substrate, is a minute deep recess formed by locally chipping the surface of the glass substrate.

The thickness of the glass substrate where the crack is formed is a little bit thinner than that of other parts of the substrate. The crack is formed in a minute-length line shape. As used herein, minute-length means a dot, a micrometer-length, a millimeter-length, or a centimeter-length.

The scribing equipment permits the crack formed on the surface of the substrate to grow in a direction of the thickness of the substrate by locally heating. The scribing equipment includes a laser light source as a heat source and a laser scanning unit. The scribing equipment has a stage for holding the mother substrate.

A step to divide the pair of base substrates 400 has a first scribing step (ST11) and a second scribing step (ST2), as shown in FIG. 4. The first scribing step (ST1) includes a step to form a first crack by using the cracking equipment (ST11) and a step to form a first scribe line by using the scribing equipment (ST12). The step ST2 includes a step to form second and third cracks (ST21) by using the cracking equipment, and a step to form a second scribe line by using the scribing equipment (ST22).

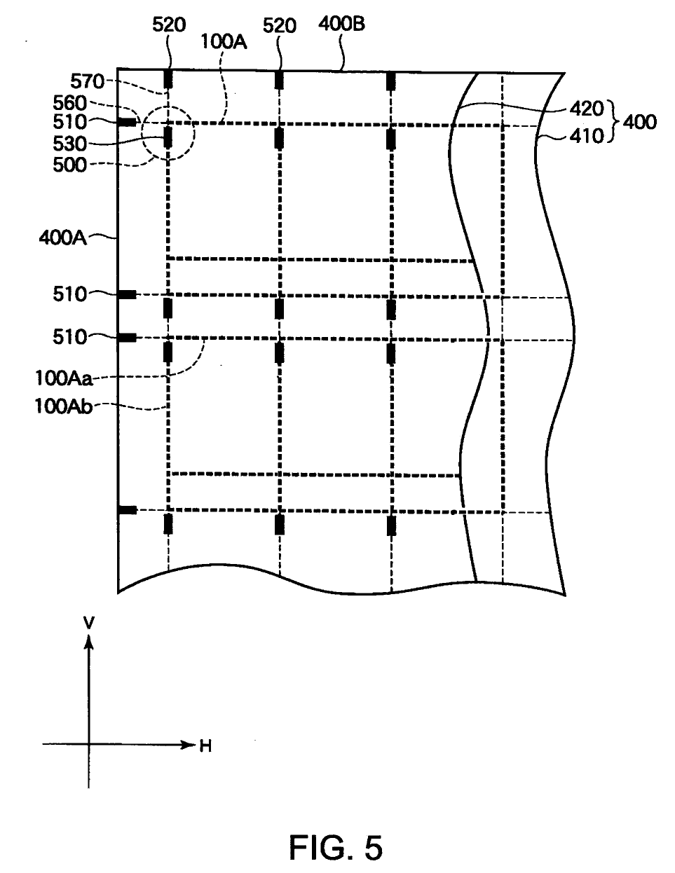

With reference to FIG. 5, in the above method of the first embodiment for manufacturing a liquid crystal display device, the cracking equipment moves down toward one side 400A of the mother substrate 400 by the step (ST11). Next, the cracking equipment contacts the one side 400A extended in the column direction V (namely the first direction) of the outer surface of mother substrate 400. Then the cracking equipment contacts at an end 100Aa extended in the row direction H (namely the second direction) of the panel area 100A and the cracking equipment makes a first crack 510 having a predetermined length and width by pressing. After this, the cracking equipment moves up away from the mother substrate.

The cracking equipment then moves in the column direction V of the substrate in order to form other first cracks 510 at the other positions by the same method as described above. Then the first cracks 510 are irradiated by laser with the scribing equipment in the step ST12. Accordingly, the scribing equipment heats the surface of the glass substrate and permits the cracks to grow. In addition, the surface is irradiated by laser along the first crack 510 to the row direction H. In this way, the crack is grown and a first scribe line 560 is formed.

The first scribe line 560 is formed at the end 100Aa on the panel area. In the step ST21, the cracking equipment moves down toward and contacts one side 400B extended in the row direction H of the mother substrate. Next, the cracking equipment contacts at an end 100Ab extended in the column direction V of the panel area 100A. Then the cracking equipment makes a second crack 520 having a predetermined length and width by pressing. After this, the cracking equipment moves up away from and leaves the mother substrate.

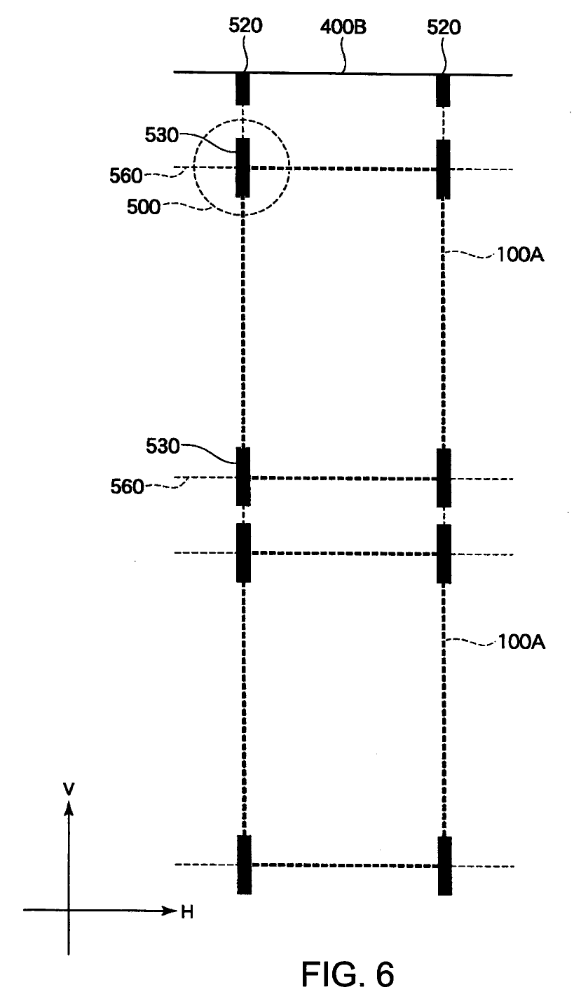

A third crack 530 is formed with the cracking equipment. The cracking equipment makes the third crack 530 at an intersection 500, as shown in FIG. 6. The intersection 500 is an area where a first scribe line 560 intersects with the line of the column direction V (namely first direction) through the second crack 520. The cracking equipment moves in the column direction V from the position where the second crack 520 is formed. Then the cracking equipment moves down toward and contacts the intersection 500 and applies pressure to it successively.

The cracking equipment moves further in the column direction V of the mother substrate while pressing. Next, the cracking equipment moves up away from and leaves the mother substrate after passing over the first scribe line 560. The third cracks 530 which intersect with the first scribe line 560 are formed. Next, the cracking equipment moves further in the column direction V of the mother substrate and forms third crack 530 at the other intersections 500 in the same way. After this, the cracking equipment leaves the mother substrate and moves in the row direction H of the mother substrate. The cracking equipment starts forming the second crack 520 and third crack 530 from the other point in which the extension of the end 100Ab intersects the one side 400B once again.

After that, in the step ST22, the scribing equipment irradiates the laser along the second crack 520 to the column direction V and through the third crack 530. As a result, the crack grows and forms a second scribe line 570, which is formed at the end 100Ab extending in the column direction V of the panel area 100A. Next, the pair of mother substrates 400 are reversed and pressed at the positions corresponding to the scribe lines. Therefore the crack on each scribe line grows more in a direction of the thickness of the substrate.

Accordingly, the array substrate and the counter substrate are divided from the mother substrate. Preferably, the scribing equipment cools the surface of the substrate after heating by laser irradiation. This enables the glass substrate to be divided easier.

In according to the above method of the first embodiment for manufacturing a liquid crystal display device, a number of the third cracks 530 formed at the intersections 500 assist in the cracking growth of the second scribe line in a straight line, whereby the cracking growth of the second scribe line 570 is formed without stopping at the intersection 500 which intersects with the first scribe line 560. Accordingly, the second scribe lines 570 are contiguously formed so as to prevent failures of dividing the liquid crystal display panel from the pair of mother substrates 400.

Particularly, this method serves to prevent crack initiation at the corner of the liquid crystal display panel (namely one part of the intersection where the first scribe line 560 intersects with the second scribe line 570). Accordingly, the method of manufacturing a liquid crystal display device according to the first embodiment improves yield.

A method for manufacturing a liquid crystal display device according to a second embodiment of the present invention will be described. The same components of the present embodiment as those of the above-described embodiment are denoted by the same reference numbers and will not be described below in detail. The steps ST11, ST12 and ST22 of the first embodiment are practiced in the same way in the second embodiment. The step ST21 will be described in detail.

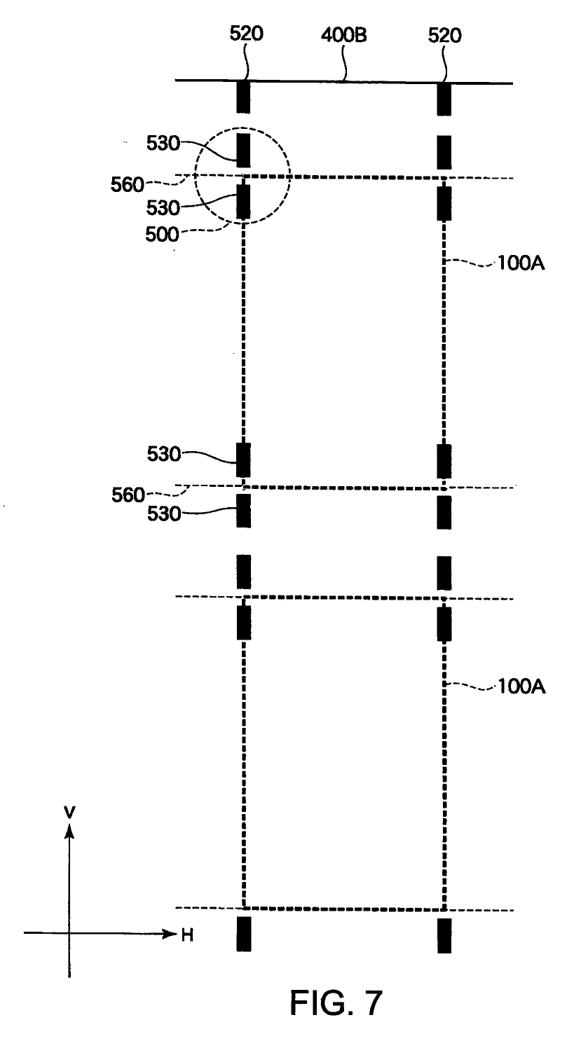

As shown in FIG. 7, the cracking equipment contacts one side 400B extended in the row direction H of the mother substrate. Then the cracking equipment makes the second crack 520 having a predetermined length and width by pressing, in the step ST21. Next, the cracking equipment moves up away from and leaves the mother substrate, and moves in the column direction V. After this, the cracking equipment stops short before the first scribe line 560 of the intersection 500, moves down toward and contacts the mother substrate and presses.

The cracking equipment moves further in the column direction V of the mother substrate while pressing. Then the cracking equipment stops short before the position where the line in the column direction V intersects with the first scribe line 560, and moves up away from and leaves the mother substrate. After this, the cracking equipment moves down toward and presses the mother substrate again after passing over the first scribe line 560.

The cracking equipment moves up away from and leaves the mother substrate after it moves further in the column direction V of the mother substrate while pressing. Therefore the third cracks 530 are formed at the intersection 500 except on the first scribe line, namely, one of the third cracks 530 is located upstream of the first scribe line 560 and the other is located downstream of the first scribe line 560 in the direction in which the cracking equipment moves. Briefly stated, two third cracks 530 are located away from the first scribe line 560.

A number of the third cracks 530 formed at the intersection 500 assist in the cracking growth of the second crack 520 in a straight line, whereby the cracking growth of the second crack 520 is formed so as not to stop at the third cracks 530.

Accordingly, the method of manufacturing a liquid crystal display device according to the second embodiment improves yield. In addition, in the second embodiment, the third cracks 530 are formed except on the first scribe line 560. This method serves to prevent crack initiation when forming the third crack 530.

A method for manufacturing a liquid crystal display device according to a third embodiment of the present invention will be described.

The steps ST11, ST12 and ST22 of the first embodiment are practiced in the same way in the third embodiment. The step ST21 will be described in detail.

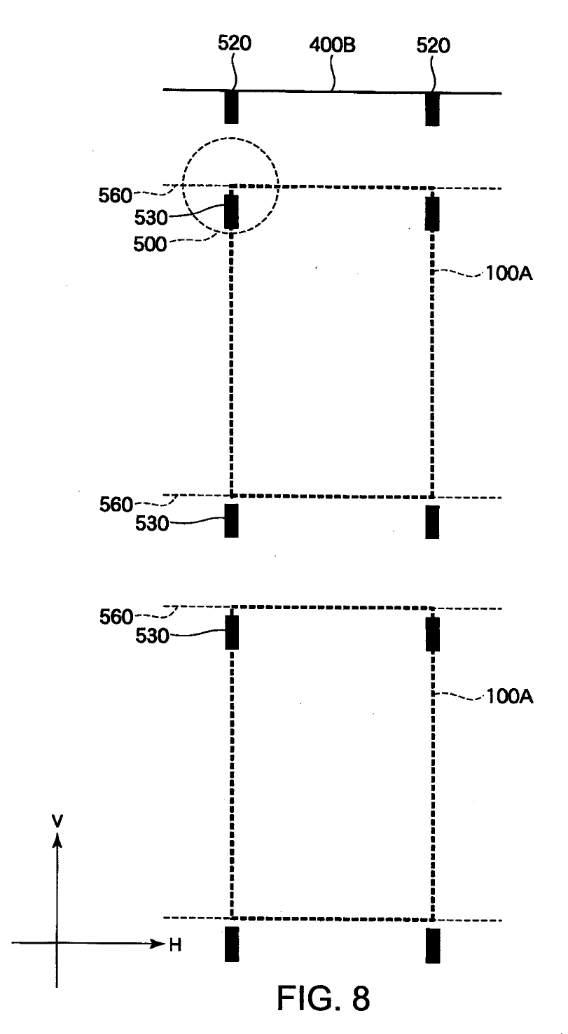

As shown in FIG. 8, in the step ST21, the cracking equipment moves down toward and contacts the one side 400B extended in the row direction H of the mother substrate. Next, the cracking equipment makes the second crack 520 having a predetermined length and width by pressing. Then the cracking equipment moves up away from and leaves the mother substrate, and moves in the column direction V. After this, the cracking equipment passes over the first scribe line 560, moves down toward and contacts the mother substrate and presses.

The cracking equipment moves further in the column direction V of the mother substrate while pressing. After that, the cracking equipment moves up away from and leaves the mother substrate. Therefore the third crack 530 that is located downstream of the first scribe line 560 in the direction, in which the cracking equipment moves, namely, located away from the first scribe line 560, is formed at the intersection 500.

In other words, the first scribe lines are sandwiched between the third cracks 530 and the second cracks 520. The method for manufacturing a liquid crystal display device according to the third embodiment achieves the same result as that in the second embodiment.

In the above embodiments, the step to divide the mother substrate is not limited to the order shown in FIG. 4. For instance, the steps may be performed in the order ST11, ST21, ST12 and ST22.

In the methods for manufacturing a liquid crystal display device according to the second and third embodiments, the distance between the first scribe line 560 and the third crack 530 may be in the range from 0.7 to 1.2 millimeters in length, for example 1.0 millimeters in length. This prevents the cracking growth of the second crack 520 from stopping.

In accordance with the above described, the present invention provides the method for manufacturing a liquid crystal display device to improve yield. Using independent cracking equipment or scribing equipment (i.e., the cracking equipment and the scribing equipment are independent elements) may achieve twice the speed than using integrated equipment (i.e., the cracking equipment and the scribing equipment are integrated as one unit).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for manufacturing a liquid crystal display device, comprising:
forming a first crack, on a mother substrate for use in a liquid crystal display device, on one side of the mother substrate extending along a first direction;
forming a first scribe line by laser irradiation along the first crack in a second direction which intersects with the first direction;
forming a second crack on one side extending along a second direction on the mother substrate;
forming a third crack at an intersection where the first scribe line intersects with a line in the first direction through the second crack; and
forming a second scribe line by laser irradiation along the second crack in the first direction through the third crack.

2. The method for manufacturing a liquid crystal display device of claim 1, further including continuously forming the third cracks at the intersections where the first scribe lines intersect with the line in the first direction.

3. The method for manufacturing a liquid crystal display device of claim 1, further including forming the third cracks near the intersections where the first scribe lines intersect with the line in the first direction.

4. The method for manufacturing a liquid crystal display device of claim 1, further including forming two of the third cracks near the intersections where the first scribe lines intersect with the line in the first direction, so as to interpose the first scribe line between the two third cracks.

5. The method for manufacturing a liquid crystal display device of claim 3, further including providing a distance of from 0.7 mm to 1.2 mm between the first scribe line and the third crack.

6. The method for manufacturing a liquid crystal display device of claim 4, further including providing a distance of from 0.7 mm to 1.2 mm between the first scribe line and the third cracks.

7. The method for manufacturing a liquid crystal display device of claim 1, further including using a dividing apparatus to form the first crack, the first scribe line, the second crack, the third crack, and the second scribe line.

8. The method for manufacturing a liquid crystal display device of claim 7, further including providing the dividing apparatus to include cracking equipment and scribing equipment.

9. The method for manufacturing a liquid crystal display device of claim 8, further including providing the cracking equipment to include a crack blade.

10. The method for manufacturing a liquid crystal display device of claim 9, further including providing the crack blade to be made of a material harder than glass.

11. The method for manufacturing a liquid crystal display device of claim 8, further including providing the cracking equipment to include a stage for holding the mother substrate.

12. The method for manufacturing a liquid crystal display device of claim 1, wherein forming the first, second, or third crack further includes locally chipping a surface of the mother substrate to form the first, second, or third crack as a recess.

13. The method for manufacturing a liquid crystal display device of claim 12, further including forming the first, second, or third crack in a minute-length line shape of a dot, a micrometer-length, a millimeter-length, or a centimeter-length.

14. The method for manufacturing a liquid crystal display device of claim 8, further including providing the scribing equipment to include a laser light source and a laser scanning unit.

15. The method for manufacturing a liquid crystal display device of claim 8, further including providing the scribing equipment to include a stage for holding the mother substrate.

16. The method for manufacturing a liquid crystal display device of claim 8, further including providing the cracking equipment and the scribing equipment as an integrated unit.

17. The method for manufacturing a liquid crystal display device of claim 8, further including providing the cracking equipment and the scribing equipment as independent elements.

18. A mother substrate for use of manufacturing a liquid crystal display device comprises:
a substrate made of glass;
a plurality of panel areas formed on the substrate in a matrix shape;
first and second scribe lines between adjacent panel areas extending along first and second directions and the first direction intersecting with the second direction;
a first crack formed on one side of the substrate extending along the first direction on the substrate;
a second crack formed on one side of the substrate extending along the second direction on the substrate; and
a third crack formed at an intersection where a line in the second direction through the first crack intersects with a line in the first direction through the second crack.

19. The mother substrate according to claim 18, wherein each of the panel areas includes a switching transistor and a pixel electrode so as to form the pixel of the liquid crystal display device.

20. The mother substrate according to claim 18, wherein each of the panel areas includes a common electrode so as to form a pixel of the liquid crystal display device.

21. A liquid crystal display device, including a panel of manufacture prepared by process comprising the steps of:
(a) a step to provide first and second mother substrates each including,
a substrate made of glass, a plurality of panel areas formed on the substrate in a matrix shape,
first and second scribe lines between adjacent panel areas extending along first and second directions and the first direction intersecting with the second direction,
a first crack formed on one side of the substrate extending along the first direction on the substrate,
a second crack formed on one side of the substrate extending along the second direction on the substrate,
a third crack formed at an intersection where a line in the second direction through the first crack intersects with a line in the first direction through the second crack, respectively;
(b) a step to attach the first and second mother substrates forming a gap therebetween by a sealing member;
(c) a step to inject a liquid crystal material in the gap; and
(d) a step to divide the first and second mother substrates into each panel area along the scribe lines so as to form a panel.

22. The liquid crystal display device according to claim 21, wherein each of the panel areas of the first mother substrate includes a switching transistor and a pixel electrode, and each of the panel areas of the second mother substrate includes a counter electrode, respectively.
